(19) United States
(12) Patent Application Publication
(10) Pub. No.: US 2014/0181746 A1
(43) Pub. Date: Jun. 26, 2014

(54) ELECTRIONIC DEVICE WITH SHORTCUT FUNCTION AND CONTROL METHOD THEREOF

(71) Applicant: GIGA-BYTE TECHNOLOGY CO., LTD., New Taipei City (TW)

(72) Inventor: Kuo Jung Lo, New Taipei City (TW)

(73) Assignee: GIGA-BYTE TECHNOLOGY CO., LTD., New Taipei City (TW)

(21) Appl. No.: 13/845,585

(22) Filed: Mar. 18, 2013

(30) Foreign Application Priority Data
Dec. 26, 2012 (TW) 101150199

(51) Int. Cl. G06F 3/0488

(52) U.S. Cl. CPC G06F 3/0488
USPC 715/835

(57) ABSTRACT

An electronic device used to perform a control method of shortcut function, includes a body, a control unit, at least one button and a touchscreen. The control unit is disposed in the body, for executing a program code. The button and the touchscreen are disposed on the body. The touchscreen includes a main touch-control area and an auxiliary touch-control area. The main touch-control area displays a shortcut icon corresponding to the program code. When the shortcut icon is triggered by a touch, the program code is executed. At least one hotkey region is defined corresponding to the button in the auxiliary touch-control area. When the touchscreen detects that the shortcut icon is dragged to overlap with the hotkey region, the control unit sets the button as a shortcut hotkey corresponding to the program code. Therefore, the control unit will execute the program code as the button is pressed.

### CROSS-REFERENCES TO RELATED APPLICATIONS

This non-provisional application claims priority under 35 U.S.C. §119(a) on Patent Application No. 101150199 filed in Taiwan, R.O.C. on 2012 Dec. 26, the entire contents of which are hereby incorporated by reference.

### BACKGROUND

1. Technical Field

This disclosure relates to an electronic device with shortcut function and a control method thereof, and more particularly to an electronic device with shortcut function and a control method thereof, in which a button or a hotkey region is set to link to a specific program code, so as to quickly start the program code or execute the function in the program code.

2. Related Art

With rapid advancement of touch detection and control technology, touchscreens have been widely used in various current electronic devices, such as smart phones, tablet computers, and notebook computers. And with combination of the technologies of the touchscreen and the display, touchscreens are further imported into many traditional electronics, such as the desktop displays, smart home appliances, and even large-scale electronic bulletin boards. The application of the touchscreen is expanding and gradually becomes one of the indispensable functions of current electronic devices.

The breakthrough of touch detection and control technology makes multi-touch combined with the handwriting recognition gradually replaces traditional keyboards and mice. The advantage of the touchscreen is that it spares space of the original input module, so as to make the electronics easy-carrying. Besides, the touchscreen provides a two-way interactive feature from one-way information read, that is, from output only to both input and output, which greatly enhances users' willingness to use.

For the above reasons, physical buttons in hardware of the current electronic devices have gradually been simplified, and even the majority of the original function keys fixed around the touchscreen are canceled and replaced by the touch tracking recognition. However, while physical buttons have been gradually replaced by the touch tracking recognition, programs supporting the touch tracking recognition have become increasingly complex as well. In order to make the touch tracking recognition corresponding to different types of programs, users often need to define touch track or touch gesture before using these programs, or to take time to understand the default input method. These disadvantages will inevitably reduce users' willingness to use.

Besides, the touch tracking recognition must be achieved by the detection of the touchscreen. When the touchscreen are turned off, the touch tracking recognition can not be achieved or executed. For extending the standby time, most current mobile devices turns the touchscreens off when not in use. Therefore, depending only on the touch tracking recognition will bring about the difficulty that users are unable to input any command or message while the touchscreen is turned off.

### SUMMARY OF THIS DISCLOSURE

In view of the above problems, this disclosure provides an electronic device with shortcut function and a control method thereof. A button or a hotkey region is set to link to a specific program code, so as to quickly start to execute the program code and to solve the inconvenience that the settings of the touch tracking recognition is too complex or that time must be taken to understand the settings of the touch tracking recognition of different programs.

The electronic device with shortcut function includes a body, a control unit, at least one button, and a touchscreen. The control unit is disposed in the body, for executing at least one program code. The button and the touchscreen are disposed on the body and electronically connected to the control unit. The touchscreen further includes a main touch-control area and an auxiliary touch-control area. The main touch-control area is for displaying a shortcut icon corresponding to the program code. When the shortcut icon is triggered, the touchscreen generates and transmits an execute signal to the control unit, so as to execute the program code corresponding to the shortcut icon. The auxiliary touch-control area defines at least one hotkey region corresponding to the button. When the touchscreen detects that the shortcut icon in the main touch-control area is dragged to overlap with the hotkey region, the control unit generates and transmits a setting signal to the button, so as to set the button as a shortcut hotkey linking to the program code. Therefore, when the button is pressed, the button generates and transmits a control signal to the control unit, and the control unit executes the program code.

Corresponding to the aforesaid electronic device, this disclosure provides a control method of shortcut function, which applies to the aforesaid electronic device with shortcut function. The control method includes the following steps: executing at least one program code by a control unit; displaying a shortcut icon corresponding to the program code in a main touch-control area of a touchscreen; dragging the shortcut icon to overlap with a hotkey region in the auxiliary touch-control area; transmitting a setting signal to a button by the control unit, so as to set the button as a shortcut hotkey linking to the program code; detecting a pressing by the button; generating and transmitting a control signal to the control unit by the button; and executing the program code by the control unit.

The electronic device of this disclosure keeps a few physical buttons, and the touchscreen are divided in to plural regions including at least one hotkey region. While setting, what the users need to do is to drag a shortcut icon of a program code to overlap the shortcut icon with the hotkey region, and then such a physical button is set as a shortcut hotkey linking to the program code. Therefore, when the button is pressed, the control unit executes the corresponding program code. The setting is very intuitive, and hotkeys for common functions can be set quickly according to the user preferences, substantially increasing the operating convenience.

Besides, the physical buttons or the hotkey region in the auxiliary touch-control area is independent of the main touch-control area. Therefore, users are able to execute the set program functions via the physical buttons or the hotkey region even when the touchscreen is turned off due to the idling of the electronic device. When doing so, the control unit starts the corresponding program code and then executes the corresponding function.

The detail of this disclosure can be better appreciated from the following detailed description of this disclosure, taken in conjunction with the attached drawings.

### BRIEF DESCRIPTION OF THE DRAWINGS

This disclosure will become more fully understood from the detailed description given herein below for illustration only, and thus not limitative of this disclosure, wherein:

FIG. 1 is a perspective view of the electronic device with shortcut function.

FIG. 2 is a block diagram of the electronic device with shortcut function.

FIG. 3 is a schematic view of the planning of the touchscreen in the electronic device with shortcut function.

FIG. 4 is a flowchart of the settings of the control method of shortcut function according to a first embodiment.

FIG. 5 is a schematic view of the setting of the control method of shortcut function according to the first embodiment.

FIG. 6 is a schematic view of the setting of the control method of shortcut function according to the first embodiment.

FIG. 7 is a flowchart of the execution of the control method of shortcut function according to the first embodiment.

FIG. 8 is a flowchart of the reset of the control method of shortcut function according to the first embodiment.

FIG. 9 is a schematic view of the reset of the control method of shortcut function according to the first embodiment.

FIG. 10 is a flowchart of the settings of the control method of shortcut function according to a second embodiment.

FIG. 11 is a flowchart of the execution of the control method of shortcut function according to the second embodiment.

FIG. 12 is a flowchart of the reset of the control method of the shortcut function according to the second embodiment.

### DETAILED DESCRIPTION OF THE DISCLOSURE

This disclosure provides an electronic device with shortcut function and a control method thereof. Two embodiments are included and will be respectively described in the followings.

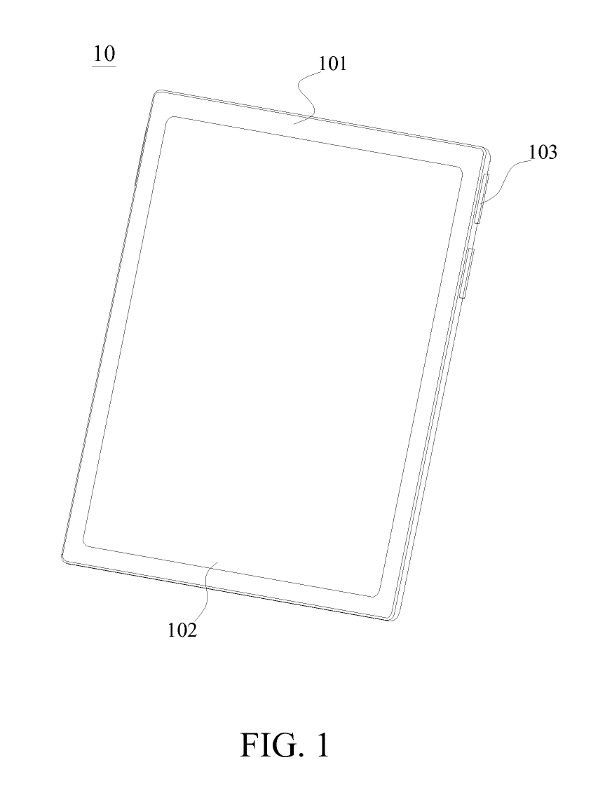

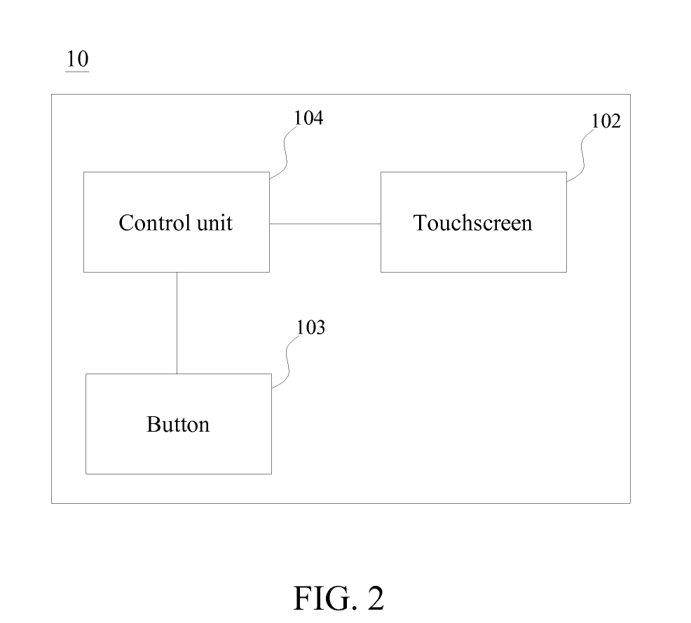

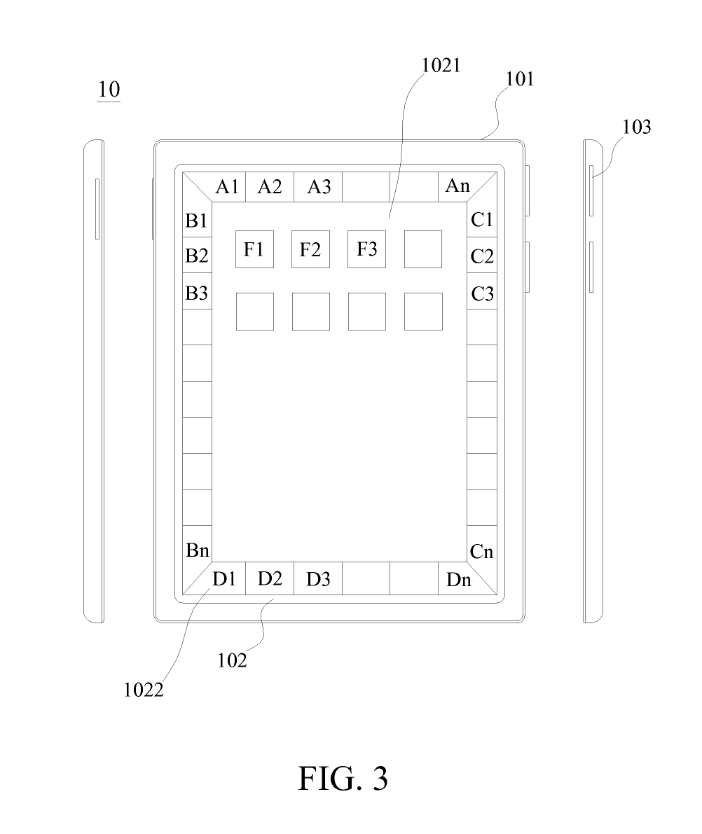

Refer to FIG. 1, FIG. 2, and FIG. 3, an electronic device 10 according to the first embodiment includes a body 101, a touchscreen 102, at least one button 103, and a control unit 104. The electronic device 10 is but not limit to a smart phone, a tablet computer, a notebook computer, a desktop screen or an electronic bulletin board, and the touchscreen 102 is but not limit to a resistive touchscreen or a capacitive touchscreen.

The control unit 104 is disposed in the body 101 and used to execute at least one program code. The program code is but not limit to a built-in application within an operating system or the other application purchased. If the electronic device is a smart phone or a tablet computer, the program code could be a mobile application. The button 103 and the touchscreen 102 are disposed on the body 101 and electronically connected to the control unit 104. People having ordinary skill in the art can make proper modification to the position of the button 103 according to the actual needs or design requirements, not limited as described herein.

Refer to FIG. 3, the touchscreen 102 further includes a main touch-control area 1021 and a auxiliary touch-control area 1022. The main touch-control area 1021 is for displaying a shortcut icon corresponding to the program code, such as F1, F2, F3, etc. These shortcut icons could be a shortcut that starts the program code or a command that executes a function of the program code. Take Windows™ operating system as an example, the shortcut icons, such as F1, F2, F3, etc, could be a shortcut that starts a program code on the desktop or a command that adjusts computer system settings. And take a music play application as an example, the shortcut icons could be a shortcut that start the application or a command that executes “Play”, “Fast-forward”, or “Pause”. When the shortcut icon in the main touch-control area 1021 is triggered, the touchscreen 102 detects this and transmits an execute signal to the control unit 104, so as to execute the program code or the command corresponding to the shortcut icon.

At least one hotkey region is defined within the auxiliary touch-control area 1022 in the touchscreen 102. The hotkey region corresponds to the button 103, and the positions thereof do not limit to one side of the touchscreen 102. As shown in FIG. 3, the hotkey region could be in the upper side of the touchscreen 102, such as A1, A2, A3, etc, the left side of the touchscreen 102, such as B1, B2, B3, etc, the right side of the touchscreen 102, such as C1, C2, C3, etc, or the lower side of the touchscreen 102, such as D1, D2, D3, etc. In the following description, the invention will take the hotkey region in the upper side of the touchscreen 102 as an illustration.

The control method of shortcut function will be described in three implementations, that is, setting, execution, and reset.

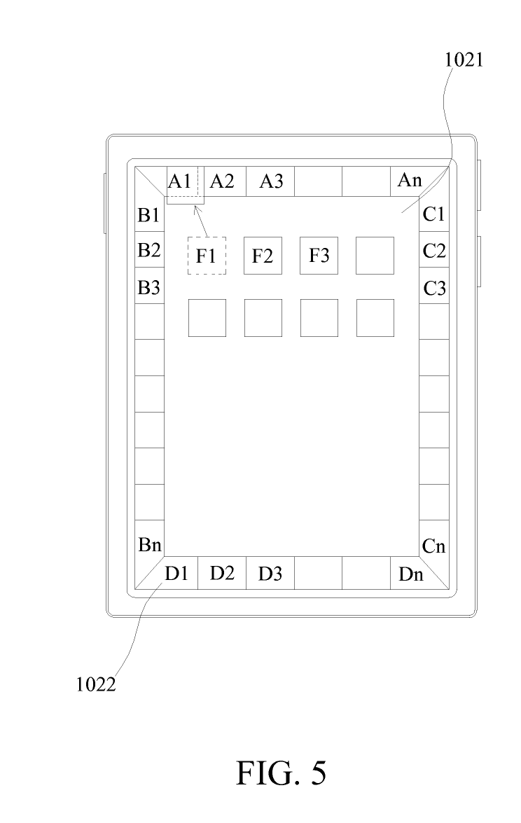

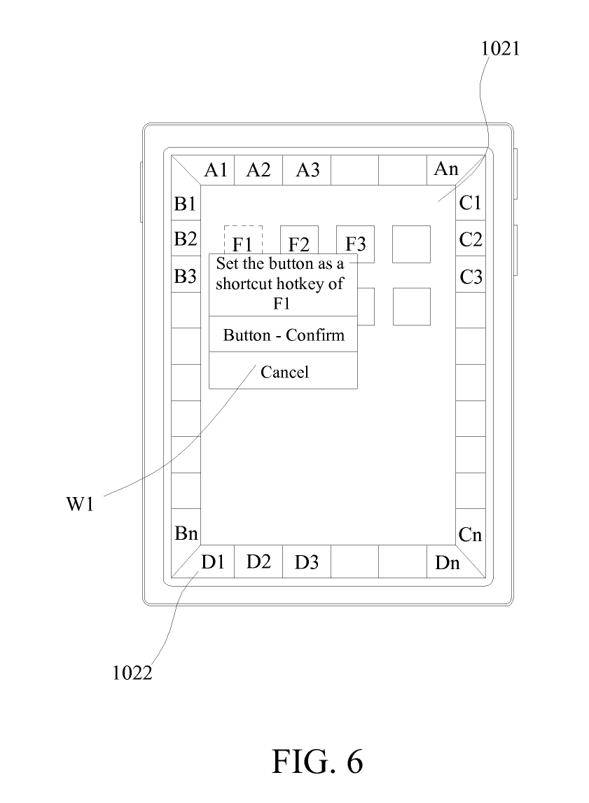

Refer to FIG. 1 to FIG. 6, the setting of the control method of shortcut function includes the following steps. First step is to execute the program code via the electronic device 10 (S101) and display the shortcut icons, such as F1, F2, F3, etc, corresponding to the program code via the main touch-control area 1021 in the touchscreen 102 (S105). When users want to set hotkeys, as shown in FIG. 5, users drag the shortcut icon F1 in the main control area 1021 to the auxiliary touch-control area 1022 and make the shortcut icon F1 overlapping with hotkey region A1 corresponding to the button 103 (S110). Control the touchscreen 102 to display a setting window as FIG. 6 (S115) via the control unit, so as to confirm or cancel the setting. Meanwhile, detect the setting in the setting window W1 via the touchscreen (S120), and transmit a signal to the control unit 104. The control unit 104 determines whether to set the button 103 corresponding to the hotkey region A1 as the shortcut hotkey according to the signal (S125). If the determination says yes, generate and transmit a setting signal to the touchscreen 102 via the control unit 104 to set the button 103 as the shortcut hotkey linking to the program code (S130), and hence complete the setting of shortcut function. At this time, press the button 103 linking to the program code will start the shortcut or the command that the shortcut icon F1 represents. Otherwise, if the determination says no, it means that users cancel to set the button 103 as the shortcut hotkey, and the control unit 104 will not act. Meanwhile, the setting window W1 displayed by the touchscreen 102 is turned off.

Take the above two example to further illustrate. In the situation that the program code executed by the control unit 104 is Windows operating system and that the shortcut icon F1 displayed on the touchscreen 102 is a shortcut that starts a word processor, when users drag the shortcut F1 to the auxiliary touch-control area 1022, make the shortcut F1 overlapping with the auxiliary touch-control area 1022, and confirm these steps, the button 103 is set to be the shortcut hotkey that start the word processor in Windows operating system. In the situation that the program code executed by the control unit 104 is a music player and that the shortcut icon F1 displayed on the touchscreen 102 is the command “Play”, when users drag the shortcut icon F1 to the auxiliary touch-control area 1022 to make the shortcut F1 overlapping with the auxiliary touch-control area 1022, and confirm these steps, the button 103 is set to be the shortcut hotkey that executes the command “Play”.

The followings makes the setting step more simple and intuitive. When users drag the shortcut icon F1 in the main touch-control area 1021 to the auxiliary touch-control area 1022 and make the shortcut icon F1 in the main touch-control area 1021 overlapping the auxiliary touch-control area 1022 in step S110, the control unit 104 can omit procedure of displaying the setting windows, detecting the setting, and the determination in the steps S115, S120, and S125 and directly executes the step S130, that is, the control unit 104 generates and transmits a setting signal to the touchscreen 102, so as to set the button 103 as the shortcut hotkey linking to the program code. In other words, when users drag the shortcut icon F1 to the auxiliary touch-control area 1022 and make the short icon F1 overlapping with the hotkey region A1, the setting of assigning the button 103 as the shortcut hotkey linking to the program code is completed, which simplifies the setting procedure and enhances the operating convenience.

Besides, for avoiding the wrong determination of the control unit 104 due to the incorrect dragging and overlapping, in the step S110 of dragging the shortcut icon F1 to the auxiliary touch-control area 1022, the system can be set that only when the shortcut icon overlaps over 50% of the area of the hotkey region, the control unit 104 generates and transmits a setting signal to the button 103 and set the button 103 as the shortcut hotkey linking to the program code. In other words, only when the shortcut icon F1 is dragged to the hotkey region A1 and the overlapping area of hotkey region A1 is over 50%, the control unit 104 determines that users want to set the shortcut hotkey. This could help the control unit 104 deals with the situation that the shortcut icon F1 overlaps with hotkey region A1 and another adjacent hotkey region A2. Only when the shortcut icon F1 overlaps over 50% of the area of the hotkey region A1 or A2, the shortcut hotkey is correspondingly set. People having ordinary skill in the art can make proper modification to the determination standard according to the actual needs or design requirements, not limited as described herein.

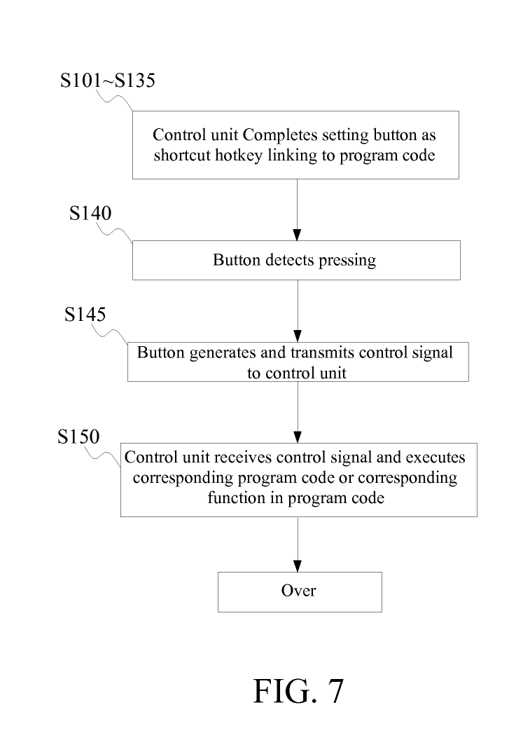

After completing the settings, users can use the shortcut function. Refer to FIG. 1, FIG. 2, FIG. 3, and FIG. 7, after the control unit 104 completes the setting of assigning the button 103 as the shortcut hotkey linking the program code in the steps S101 to S135, users press the button 103, so as to start the word processor in Windows operating system or command “Play” in the music player. The button 103 detects the pressing (S140), and the button 103 generates and transmits a control signal to the control unit 104 (S145). The control unit 104 receives the control signal and executes the corresponding program code or the corresponding function in the program code (S150).

Users can use the shortcut function to execute the set function via the button 103. Besides, when the program code is not activated or the touchscreen is turned off due to the idling of the electronic device 10, the button 103 will generates and transmits a control signal to the control unit 104 if the button 103 detects the pressing. Then the control unit 104 receives the control signal and detects that the program code is not activated or the electronic device 10 is idling, and the control unit 104 starts the program code and then executes the program code or the corresponding command. Therefore, pressing the button 103 will start the program code and then execute the command even when the electronic device 10 is idling, the touchscreen 102 is turned off, or the program code is not activated, which enhances the operating convenience.

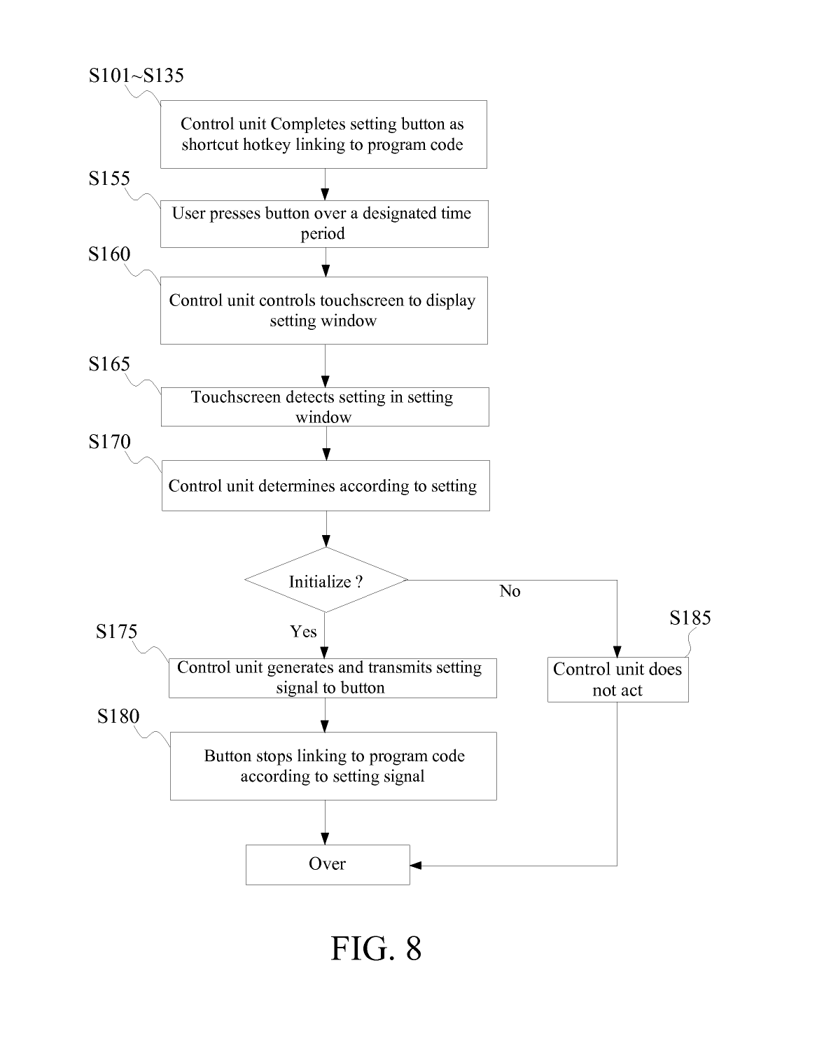

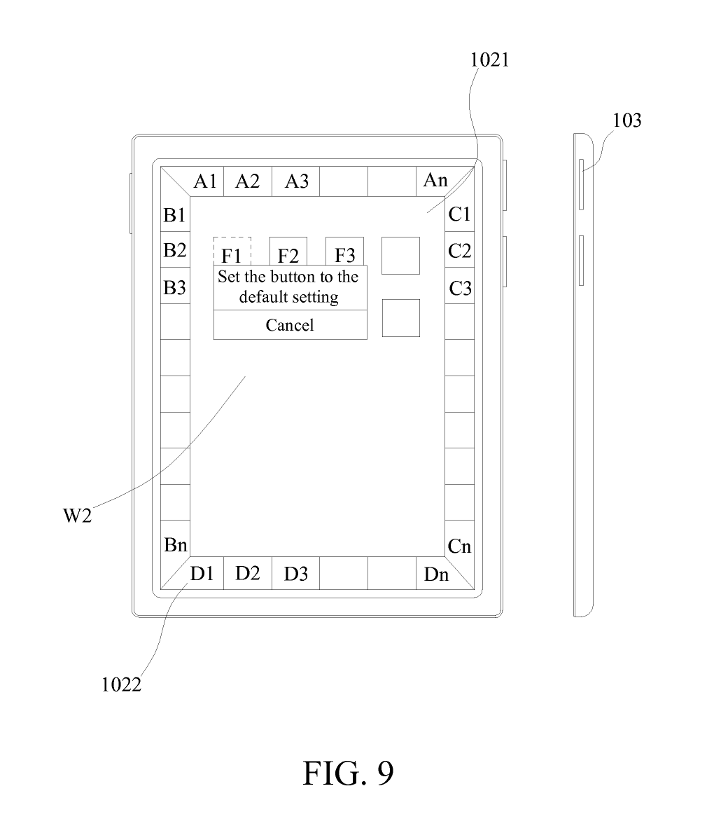

Refer to FIG. 1, FIG. 2, FIG. 3, FIG. 8, and FIG. 9, users can reset the shortcut function after the setting. After the control unit 104 completes setting the button 103 as the shortcut hotkey linking to the program code in the steps S101 to S135, users press the button 103 over a designated time period to reset the shortcut function of the button 103 (S155), and the control unit 104 control the touchscreen 102 to display a setting window W2 (S160), so as to detect whether users want to initialize the button 103. Meanwhile, the touchscreen 102 detects the setting in the setting window W2 (S165), the control unit 104 determines according to the setting (S170). If the control unit 104 determines that the setting is initialization, the control unit 104 generates and transmits a setting signal to the button 103 (S175), and then the button 103 stops linking to the program code according to the setting signal. That is, the button 103 is not the shortcut hotkey anymore, and the button 103 does not have the function of starting the program code or executing the command in the program code. Therefore, users can set, execute, or reset the shortcut hotkey according to their preferences, without complex software settings or remembering special settings of each application, which is very convenient.

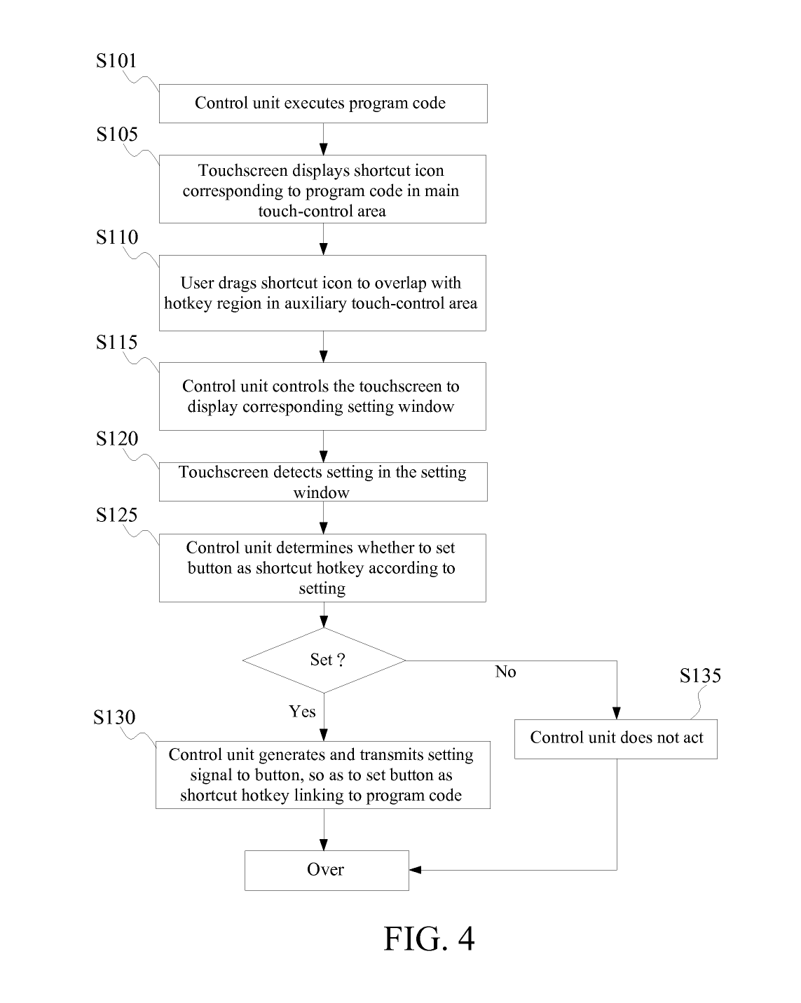

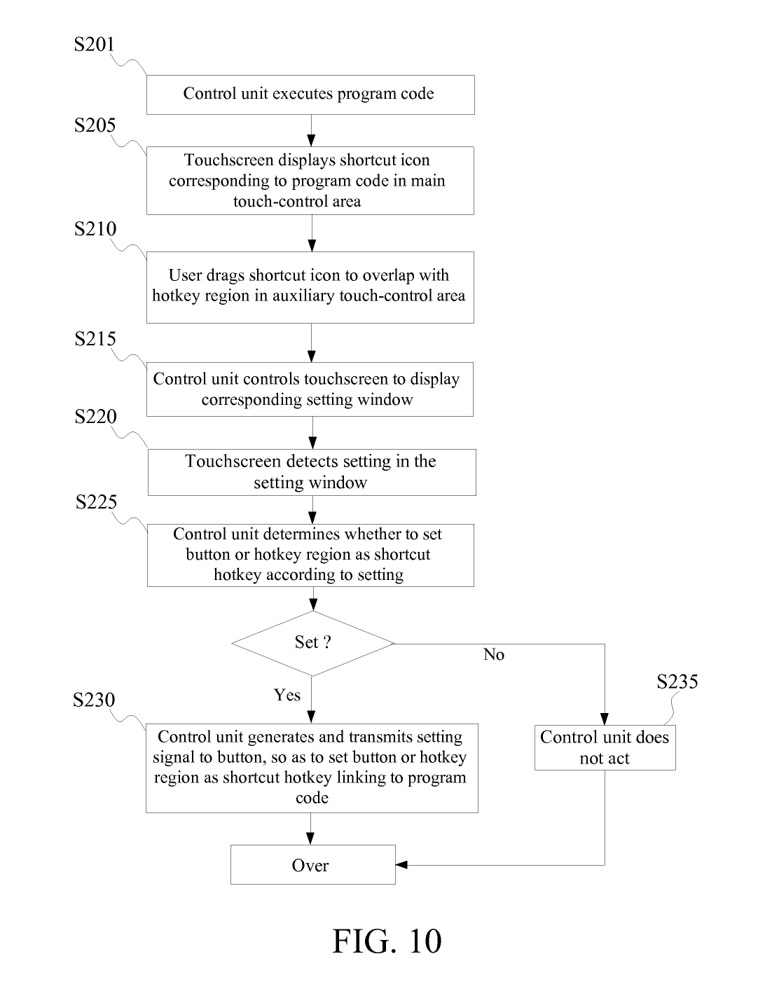

The electronic device 10 with shortcut function according the second embodiment has similar components and hardware configuration to the first embodiment. Refer to the description of the first embodiment, FIG. 1, FIG. 2, and FIG. 3, the inventor will not repeat here. The control method of shortcut function is similar to that of the first embodiment and also has three implementations, that is, setting, execution, reset. Refer to FIG. 4, FIG. 5, FIG. 6, and FIG. 10, the step S201 of executing the program code via the control unit 104 to the step S225 of determining whether the setting is assigning the shortcut hotkey are similar to the steps (S101˜S125), the inventor will not repeat here. The only difference is that in the step S230, when the control unit 104 set the button 103 as the shortcut hotkey, the control unit 104 is able to generate a setting signal to the hotkey region A1 as well to assign the hotkey region A1 as the shortcut hotkey linking the start shortcut or the command. In other words, users is able to set the button 103 and the hotkey region A1 as the shortcut hotkey at the same time, and the button 103 and the hotkey region A1 both have the shortcut function. According to the above example, after the setting, the button 103 and the hotkey region A1 have the shortcut function that starts the word processor in Windows operating system or that executes the command that plays the music. The simplification and the determination standard about the overlapping area are similar to those in the first embodiment, so the inventor will not repeat here.

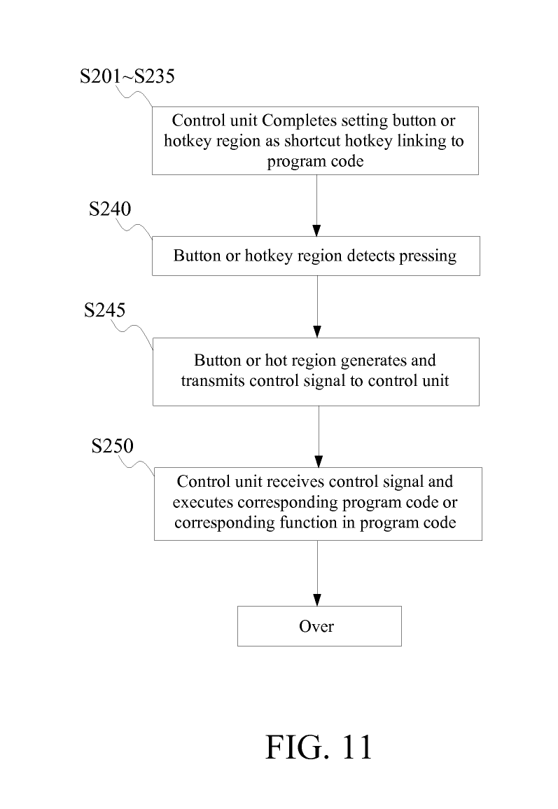

Refer to FIG. 7 and FIG. 11, after steps of setting the button 103 and the hotkey region A1 as the shortcut hotkey (S201˜S235), users is able to choose to press the button 103 or press the hotkey region A1 if users want to start the word processor in Windows operating system or execute the command “Play”. When the hotkey region A1 detects the pressing (S240), the touchscreen 102 generates and transmits a control signal to the control unit 104 (S245), and the control unit 104 receives the control signal and execute the corresponding program code or command (S250). Because the detection of the auxiliary touch-control area 1022 is independent of the main touch-control area 1021, the hotkey region A1 in the auxiliary 1022 is able to detect the pressing and execute the shortcut function even when the touchscreen 102 is turned off due to the idling of the electronic device 10. Besides, to make the hotkey region A1 able to be easily pressed when the touchscreen is turned off, designer can print corresponding grid lines or icons to facilitate the identification.

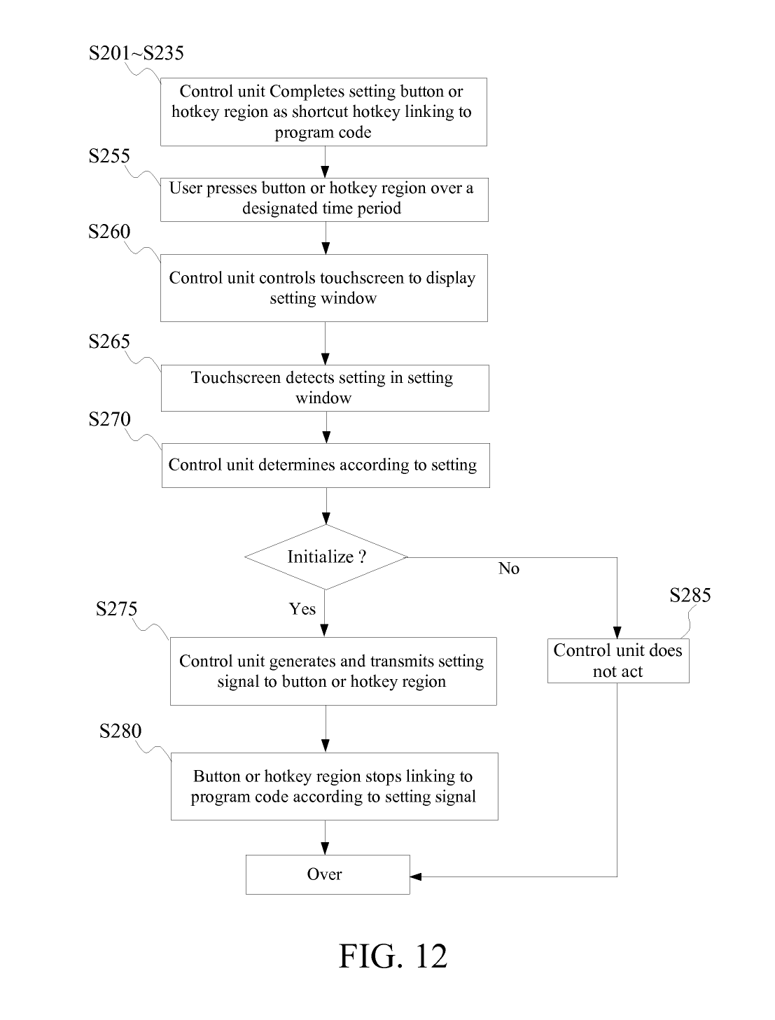

Refer to FIG. 8, FIG. 9, and FIG. 12, after the setting, user is able to press the button 103 or the hotkey region A1 to reset the shortcut function. The reset procedure is similar to that in the first embodiment. The only difference is that the hotkey region A1 is able to be reset by similar procedure. Refer to S201 to S235, S255 to S285, and the description and the drawings in the first embodiment for the detailed reset procedure, the inventor will not repeat here.

Through keeping some physical buttons and dividing the area of the touchscreen in order to define the hotkey region, users is able to set the physic button or the hotkey region as a shortcut hotkey by dragging a shortcut icon corresponding to some program codes and making the short icon overlapping with the hotkey region, without complex software setting or different setting methods according to different application. This method helps users quickly set the hotkeys corresponding to program codes in common use according to their preferences and is very intuitive. Besides, the determination standard about overlapping area avoids the incorrect determination.

The physical button and hotkey region in the auxiliary touch-control area is independent of the main touch-control area, so users can directly execute the functions in the program code by pressing the physical button or the hotkey region even when the touchscreen is turned off due to the idling of the electronic device, without triggering the shortcut icon displayed by the touchscreen. In short, the control unit is able to start the program code and execute the command according to the pressing of the physical button or the hotkey region even when the program code is not activated.

Meanwhile, when users want to reset the physical button or the hotkey region to cancel the shortcut function, pressing the physical button or the auxiliary touch-control area over a designated time period returns the default settings, which is very convenient.

Overall, the electronic device with shortcut function and the control method thereof help users quickly set the physical button or the hotkey region as the shortcut hotkey. And the easy and intuitive method of shortcut function needs no complex settings corresponding to different program codes, which greatly enhances the operating convenience and users' willingness to use.

Though the embodiments of this disclosure are disclosed as described above, this is not to limit this disclosure. People having ordinary skill in the art will recognize that this disclosure can be practiced with modification within the spirit and scope of the claim. It is therefore to be understood that this disclosure is not to be limited by the foregoing description but only by the appended claims.

What is claimed is:

1. An electronic device with shortcut function, comprising:
a body;
a control unit, disposed in the body, for executing at least one program code;
at least one button, disposed on the body and electronically connected to the control unit; and
a touchscreen; disposed on the body and electronically connected to the control unit, including:
a main touch-control area, for displaying a shortcut icon corresponding to the program code, wherein when the shortcut icon is triggered, the touchscreen generates and transmits an execute signal to the control unit, for executing the program code corresponding to the shortcut icon; and
a auxiliary touch-control area, defining at least one hotkey region corresponding to the button, wherein when the touchscreen detects that the shortcut icon in the main touch-control area is dragged to overlap with the hotkey region, the control unit generates and transmits a setting signal to the button, for setting the button as a shortcut hotkey linking to the program code;
wherein the electronic device is arranged such that when the button is pressed, the button generates and transmits a control signal to the control unit, and the control unit executes the program code.

2. The electronic device as claimed in claim 1, wherein when the touchscreen detects that the shortcut icon in the main touch-control area is dragged to overlap with the hotkey region, the control unit generates and transmits a setting signal to the hotkey region and sets the hotkey region as a shortcut hotkey linking to the program code; wherein when the hotkey region is triggered, the touchscreen generates and transmits a control signal to the control unit, and the control unit executes the program code.

3. The electronic device as claimed in claim 1, wherein when the hotkey region or the button is set as the shortcut hotkey, the control unit does not execute the program code or the electronic device is idling, and the hotkey region is triggered or the button is pressed, the touchscreen generates and transmits a control signal to the control unit, and the control unit executes the program code.

4. The electronic device as claimed in claim 1, wherein when the touchscreen detects that the shortcut icon in the main touch-control area is dragged and overlaps with the hotkey region, the control unit controls the touchscreen to display a corresponding setting window, and the touchscreen detects the setting and generates a setting signal according to the setting.

5. The electronic device as claimed in claim 1, wherein when the hotkey region or the button is pressed over a designated time period, the control unit controls the touchscreen to display a corresponding setting window, the touchscreen detects the setting, the control unit generates and transmits a setting signal to the touchscreen according to the setting, and the touchscreen stops the hotkey region or the button linking to the program.

6. The electronic device as claimed in claim 1, wherein when the touchscreen detects the shortcut icon in the main touch-control area is dragged to overlap more than 50% of the area of the hotkey region, the control unit generates the setting signal.

7. A control method of shortcut function, applying to an electronic device with a touchscreen, comprising:
executing program code by a control unit;
displaying a shortcut icon corresponding to the program code in a main touch-control area of the touchscreen;
dragging the shortcut icon to overlap with a hotkey region in an auxiliary touch-control area;
generating and transmitting a setting signal to a button by the control unit, so as to set the button as a shortcut hotkey linking to the program code;
detecting a pressing by the button;
generating and transmitting a control signal to the control unit by the button; and
executing the program code by the control unit.

8. The control method of shortcut function as claimed in claim 7, wherein the step of dragging the shortcut icon to a auxiliary touch-control area further includes:
generating and transmitting a setting signal to the hotkey region by the control unit, so as to set the hotkey region as the shortcut hotkey linking to the program code;
detecting a pressing in the hotkey region;
generating and transmitting a control signal to the control unit by the touchscreen; and
executing the program code by the control unit.

9. The control method of shortcut function as claimed in claim 7, wherein the step of generating and transmitting a control signal to the control unit by the button further includes:
starting and executing the program code by the control unit when the control unit receives a control signal and detects that the program is not activated or that the electronic device is idling.

10. The control method of shortcut function as claimed in claim 7, wherein the step of dragging the shortcut icon to a auxiliary touch-control area further includes:
controlling the touchscreen to display a corresponding setting window by the control unit;
detecting the setting in the setting window by the touchscreen; and
determining whether to set the hotkey region or the button as the shortcut hotkey according to the setting by the control unit, wherein if the setting is to set the hotkey region or the button as the shortcut hotkey, the control unit transmits a setting signal to the touchscreen and set the hotkey region or the button as the shortcut hotkey; if the setting is not to set the hotkey region or the button as the shortcut hotkey, the control unit does not act.

11. The control method of shortcut function as claimed in claim 7, wherein the step of generating and transmitting a setting signal to a button by the control unit, so as to set the button as a shortcut hotkey linking to the program code further include:
pressing the hotkey region or the button over a designated time period;
controlling the touchscreen to display a corresponding setting window by the control unit;
detecting the setting in the setting window by the touchscreen; and
generating and transmitting a setting signal to the touchscreen or the button via the control unit when the setting is to initialize the touchscreen or the button, and stopping the hotkey region or the button linking to the program code by the touchscreen or the button if the setting is an initialization action; when the setting is not to initialize the touchscreen or the button, the control unit stays still.

12. The control method of shortcut function as claimed in claim 7, wherein in the step of dragging the shortcut icon to a auxiliary touch-control area, if the shortcut icon overlaps over 50% of the area of the hotkey region, generating and transmitting a setting signal to the hotkey region or the button, so as to set the hotkey region or the button as a shortcut hotkey linking to the program code.
